(19) United States
(12) Patent Application Publication
(10) Pub. No.: US 2018/0203979 A1
(43) Pub. Date: Jul. 19, 2018

(54) ATTESTATION OF A USER'S MEDICAL CONDITION WITH A DEVICE IN A ZERO KNOWLEDGE ENVIRONMENT

(71) Applicant: International Business Machines Corporation, Armonk, NY (US)

(72) Inventors: Susann Marie KEOHANE, Austin, TX (US); James R. KRAEMER, Santa Fe, NM (US); Jeb R. LINTON, Herndon, VA (US)

(21) Appl. No.: 15/407,345

(22) Filed: Jan. 17, 2017

(51) Int. Cl. G06F 19/00

(52) U.S. Cl. CPC G06F 19/3431; G06F 19/3418; G06F 19/363

(57) ABSTRACT

A method, system and computer program product for providing an attestation of a user's medical condition. The method begins with determining if a set of one or more conditions has been satisfied using zero-knowledge verifiable computing on a processor based device, such as smart watch or cell phone. In response to the set of one or more conditions having been satisfied, sending an attestation calculated using a zero-knowledge verifiable computing technique to a second processor-based device that the set of one or more conditions have been satisfied optionally, using a zero knowledge protocol to maintain privacy of the user of the first processor-based device. In one example the information is “pulled” from the processor device in response to the set of one or more conditions having been satisfied. In another example, the information is “pushed” to the second processor-based device. The set of conditions includes medical conditions, and/or physiological conditions.

### BACKGROUND

The present invention generally relates to medical information services, and more particularly for confirming medical related information while maintaining privacy of users.

As non-traditional healthcare entities, such as, grocery stores, drug stores, and retail stores become healthcare providers, there is a need for the patient/customer to share personal health data in a private safe way. For example, it's important for the pharmacist in retail store administering a flu shot to know if the customer has the potential for a deadly reaction to the flu vaccine. Currently, the pharmacist is relying on the customer to self-disclose his/her health through a simple questionnaire. This current system is antiquated and flawed. It has resulted in life-threatening reactions to medical treatments or their ingredients e.g., antibiotics, gelatin in vaccines, or other ingredients.

Further, large multi-institutional studies often involve merging data records that have been de-identified to protect patient privacy. Unless patient identities can be reconciled across institutions, individuals with records held in different institutions can often times be incorrectly “counted” as multiple persons when databases are merged. A need exists for to describe a protocol that can reconcile individuals with records in multiple institutions.

### SUMMARY

The present invention provides an attestation of a user's medical condition. Stated differently the present invention provides the ability to provide a response that support or that opposes the veracity of a statement of a medical condition. The method includes determining on a processor-based device if a set of one or more conditions has been satisfied using zero-knowledge verifiable computing. The set of conditions includes medical conditions, physiological conditions or both. Next, in response to the set of one or more conditions having been satisfied, sending an attestation that the set of one or more conditions have been satisfied. Optionally the sending the attestation is done using a zero-knowledge protocol to maintain privacy of the user.

The method in one embodiment includes receiving a request for the attestation of the set of one or more conditions from another user using a zero-knowledge protocol to maintain privacy of the user of the first processor-based device. In another embodiment, the method includes determining if a settable time period is expired. And in response to the settable time period is expired along with the set of one or more conditions having been satisfied, sending an attestation that the set of one or more conditions to a second processor-based device have been satisfied using a zero-knowledge protocol to maintain privacy of the user.

A few examples of zero-knowledge verifiable computing include but are not limited to: a succinct computational integrity and privacy (SCIP) technique; a zero-knowledge succinct non-interactive argument of knowledge (zk-snark) technique; or a probabilistically checkable proof (PCP) technique. The proof can be whether the program is using at least one of trusted computing, secure boot attestation, verified operation of a medical application, or a combination or derivative technique thereof.

Other embodiments of the invention include a system and a computer program product.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a processor-based device worn by a user for providing attestation of a set of one or more conditions by the user, in accordance with an embodiment of the present invention;

FIG. 2 is a processor-based device of FIG. 1 coupled to a computer, in accordance with an embodiment of the present invention;

FIG. 3 is a functional diagram of providing a user's medical condition attestation, in accordance with an embodiment of the present invention;

FIG. 4 is a flow diagram of a user's medical condition attestation, in accordance with an embodiment of the present invention; and

FIG. 5 illustrates a computing node, in accordance with an embodiment of the present invention.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention is presented for purposes of illustration and description, but is not intended to be exhaustive or limited to the invention in the form(s) disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The terminology used herein is for the purpose of describing particular embodiments only and is not intended to be limiting of the invention.

In some embodiments, the conditions specified during the attestation by the processor-based device can be arbitrarily complex and may include operations on any information available to the medical device in question. The processor-based device can return to the requestor, such as caregiver, either the proof alone or proof along with additional output. In other examples the proof along with additional output is provided. This output may include any results considered appropriate to share which do not violate patient privacy. The verifiable computing technology proves that the program runs unmodified, either interactively during execution or as the program exits.

The results medical conditions with are with standard bounds include—“Normal”, “Check-up needed within 30 days”, or medical conditions with our outside standard bounds to include “Dispatch EMT immediately”—“Dispense” or “Do not dispense: Unspecified Contraindication”. The information can include any specific medical information that isn't considered a privacy concern in the immediate context.

### Non-Limiting Definitions

The terms “a”, “an” and “the” are intended to include the plural forms as well, unless the context clearly indicates otherwise.

The term “attestation” means to provide a response that support or that opposes the veracity of a statement.

The term “medical condition attestation” means an attestation of the medical condition of a user.

The terms “comprises” and/or “comprising”, when used in this specification, specify the presence of stated features, steps, operations, elements, and/or components, but do not preclude the presence or addition of one or more other features, integers, steps, operations, elements, components, and/or groups thereof.

The term “processor based device” means a smartphone, GPS, smart watch, fitness tracker, computer or any other device capable of providing a providing zero-knowledge verifiable computing environment.

The phase “set of conditions” means a medical condition, a physiological condition, or a combination of both, these conditions may be measured with one or more sensors including location, speed, altitude, body temperature, heart rate, brain activity, muscle motion, eye movement, speech analysis and others. Sensors may be part of a smart watch, wearable sensors, or communicate to a network via a smartphone.

The phrase “verifiable computing” in cryptography, is a method by which one party, the prover (also referred to herein as a “user”), can prove to another party, the verifier that a program has been or is being executed correctly and without modification or tampering.

A “zero-knowledge protocol”, in cryptography, is a method by which one party, the prover, (also referred to herein as a “user”, can prove to another party, the verifier (also referred to herein as a “service provider”) providing a service that a given statement is true, without conveying any information apart from the fact that the statement is indeed true.

The phrase “zero-knowledge verifiable computing” is a method of verifiable computing whereby a program is specially compiled to perform a function and produce a result while simultaneously computing and providing a cryptographic proof that it executed correctly in untampered-with form. The computed proof can be probabilistically checked to verify the integrity of the computation, to varying levels of assurance depending on how many bits of the proof the checker chooses to verify. This method is known in the art as a Probabilistically Checkable Proof (PCP) and may take several forms, including interactive proof during the execution of the program and non-interactive proof at the completion of the program execution. The phrase “zero-knowledge verifiable computing” is a method of verifiable computing which can also provide the proof of integrity through a zero-knowledge protocol. This combination of Verifiable Computing with a Zero-Knowledge protocol, often also using a succinct method such as Succinct Computational Integrity and Privacy (SCIP) and zero-knowledge Succinct Non-Interactive Arguments of Knowledge (zkSNARK) techniques, combining the advantages of verifiability, succinctness, and zero-knowledge operation to maximize assurance of both integrity and privacy while minimizing computational cost.

### Computer Based Device

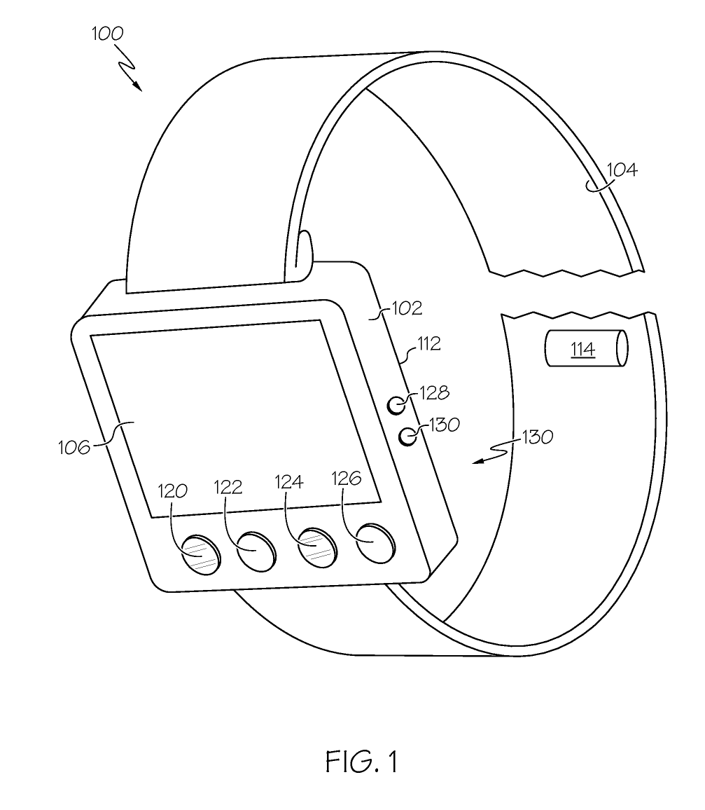

FIG. 1 is a functional diagram 100 illustrating one example of processor-based device 100. In this example the device is a wrist-watch. In other examples the process-based device may be a smartphone, GPS, fitness tracker, or other device that can measure a medical condition or physiological condition, or a combination of both of the user or wearer.

In this example, the processor-based device includes a wrist-watch sized case 102 supported on a wrist band 104. The case 102 may be of a number of variations of shape but can be conveniently made a rectangular, approaching a box-like configuration. The wrist-band 104 can be an expansion band or a wristwatch strap of plastic, leather or woven material. The processor or CPU of the wearable appliance is connected to a radio frequency (RF) transmitter/receiver (such as a Bluetooth device, a Zigbee device, a WiFi device, a WiMAX device, or an 802.X transceiver, among others.

In one embodiment, the back of the device is a conductive metal electrode 112 that in conjunction with a second electrode 114 mounted on the wrist band 104, enables differential EKG or ECG to be measured. In one embodiment where only one electrode 112 or 114 is available, an amplification may be necessary to render this signal usable for heart rate detection.

The wrist band 104 can also contain other electrical devices such as ultrasound transducer, optical transducer or electromagnetic sensors, among others. In one embodiment, the transducer is an ultrasonic transducer that generates and transmits an acoustic wave upon command from the CPU during one period and listens to the echo returns during a subsequent period. The frequency of the ultrasonic transducer's transmit signal will differ from that of the return signal, because the scattering red blood cells within the radial artery are moving. Thus, the return signal, effectively, is frequency modulated by the blood flow velocity.

An analog signal representative of the Doppler frequency of the echo is received by the transducer and converted to a digital representation by the ADC, and supplied to the CPU for signal processing. Within the CPU, the digitized Doppler frequency is scaled to compute the blood flow velocity within the artery based on the Doppler frequency. Based on the real time the blood flow velocity, the CPU applies the vital model to the corresponding blood flow velocity to produce the estimated blood pressure value.

Prior to operation, calibration is done using a calibration device and the monitoring device to simultaneously collect blood pressure values (systolic, diastolic pressures) and a corresponding blood flow velocity generated by the monitoring device.

After the calibration, the system is ready for real-time blood pressure monitoring. In an acoustic embodiment, the transducer directs ultrasound at the patient's artery and subsequently listens to the echoes therefrom. The echoes are used to determine blood flow, which is fed to the computer model to generate the systolic and diastolic pressure values as well as heart rate value. The CPU's output signal is then converted to a form useful to the user such as a digital or analog display, computer data file, or audible indicator. The output signal can drive a speaker to enable an operator to hear a representation of the Doppler signals and thereby to determine when the transducer is located approximately over the radial artery. The output signal can also be wirelessly sent to a base station for subsequent analysis by a physician, nurse, caregiver, or treating professional. The output signal can also be analyzed for medical attention and medical treatment.

In one optical embodiment, the transducer can be an optical transducer. The optical transducer can be a light source and a photo-detector embedded in the wrist band portions 104. The light source can be light-emitting diodes that generate red and infrared radiation, for example. The photo-detector detects transmission at the predetermined wavelengths, for example red and infrared wavelengths, and provides the detected transmission to a pulse-oximetry circuit embedded within the wrist-watch. The output of the pulse-oximetry circuit is digitized into a time-dependent optical waveform, which is then sent back to the pulse-oximetry circuit and analyzed to determine the user's vital signs.

In the electromagnetic sensor embodiment, the wrist band 104 is a flexible plastic material incorporated with a flexible magnet. The magnet provides a magnetic field, and one or more electrodes similar to electrode 114 are positioned on the wrist band to measure voltage drops which are proportional to the blood velocity.

The wrist-band 104 further contains one or more internal antennas 130 for transmitting or receiving radio frequency signals. The antenna 130 is electrically coupled to a radio frequency transmitter and receiver for wireless communications with another computer. Although a wrist-band is disclosed, a number of substitutes may be used, including a belt, a ring holder, a brace, or a bracelet, among other suitable substitutes known to one skilled in the art. The housing 102 contains the processor and associated peripherals to provide the human-machine interface. A display 106 is located on the front section of the housing 102. A speaker 120, a microphone 124, and a plurality of push-button switches 122, 126, 128, and 130 are also located on the front section of housing 102.

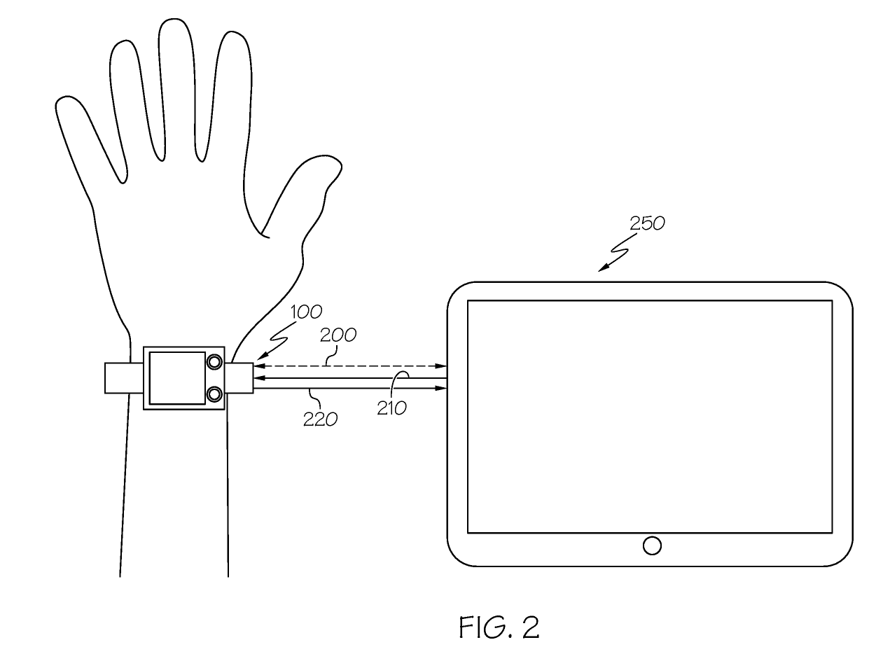

The electronic circuitry housed in the watch case 102 detects adverse conditions such as falls or seizures. In one implementation, the circuitry can recognize speech, namely utterances of spoken words by the user, and converting the utterances into digital signals. The circuitry for detecting and processing speech to be sent from the wristwatch to the second processor-based system 250 in FIG. 2 over the mesh network includes a central processing unit (CPU) connected to a ROM/RAM memory via a bus.

Processor-Based Device in Wireless Communications with Computer

FIG. 2 is a processor-based device 100 of FIG. 1 coupled to a second processor-based device 250. In this example the first processor-based device is a watch 100 that communicates wirelessly 200 to the second processor-based device which is a computer 250 over a communication radio frequency (RF) transmitter/receiver (such as a Bluetooth device, a Zigbee device, a WiFi device, a WiMAX device, or an 802.X transceiver, among others. The computer 250 can be a tablet, a smartphone, another smart watch, desktop computers, laptop computers, servers, wireless devices (e.g., mobile phones, tablets, personal digital assistants, etc.), and the like or any other device capable of communicating using a zero-knowledge protocol.

Optional notification on the watch 100 may be used to indicate activity of communications with the computer 200 including the set of conditions 210 being sent for the watch 100 to send an attestation 220 back to the computer 250 as further described below.

The protocol can be executed at high computational speed. Optionally, an encryption algorithm or 1-way hash algorithm can be employed, but in general there is no need to protect the protocol from discovery.

A zero-knowledge protocol for reconciling patients across institutions is described. This protocol is one of many computational tools that permit pathologists to safely share clinical and research data.

In another example, the system constantly monitors the user's condition in the background and when the pulse rate falls outside the normal range (say for example: the normal adult geriatric heart rate is 70-95), a notification is automatically generated and sent via the Cloud to the display device.

### Medical Condition Attestation Flow

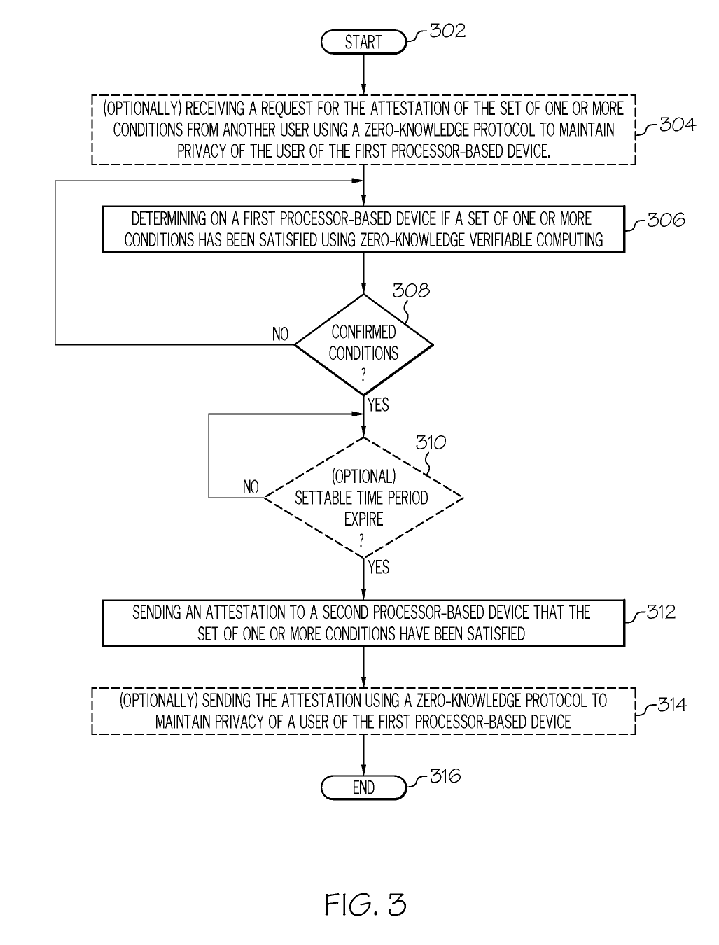

FIG. 3 is a flow diagram providing medical condition attestation. The process starts in step 302 and immediately proceeds to an optional step 304, in which a user using a second processor-based device, such as computer 250 in FIG. 2, to initiate a process, in step 302. The process immediately proceeds to step 306.

In step 306, a determination is made on a first processor-based device such as the smart watch 100 (FIG. 1 and FIG. 2) whether one or more conditions have been satisfied. In one example the conditions are medical conditions, physiological conditions, or a combination of both. These conditions may be measured with one or more sensors including location, speed, altitude, body temperature, heart rate, brain activity, muscle motion, eye movement, speech analysis and others. Sensors may be part of a smart watch, wearable sensors, or communicate to a network via a smartphone. The process then proceeds to step 308.

In step 308, if the conditions in step 306 are confirmed the process continues to optional step 310 or loops back to wait until a period of time has elapsed before continuing to step 312.

In step 312 an attestation (220, FIG. 2) is sent from the first processor-based device 100 wireless 200 to the second processor-based device 300, using a zero-knowledge protocol to maintain privacy of the user of the first processor-based device 100. The process then proceeds to step 314.

Otherwise, if the result is determined as unsuccessful, the process proceeds to step 320 to end the process.

### Generalized Computing Environment

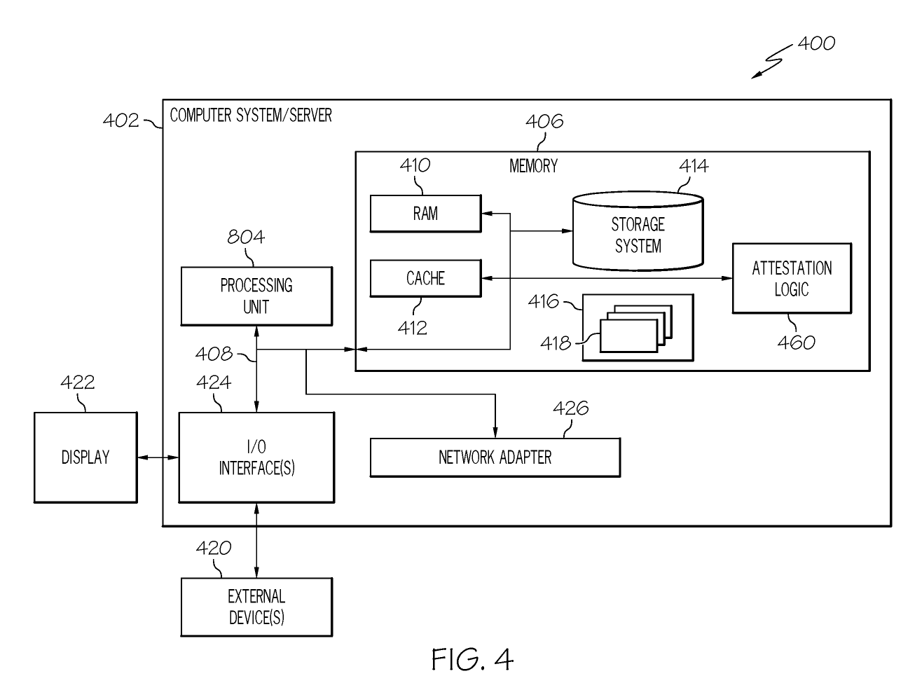

FIG. 4 illustrates one example of a processing node 400 for operating the zero-knowledge verifiable computing platform 100 or 250, in accordance with an embodiment the present invention. This example is not intended to suggest any limitation as to the scope of use or functionality of embodiments of the invention described herein and the processing node 400 is capable of being implemented and/or performing any one or more of the functionalities set forth herein.

As depicted, processing node 400 can be a computer system/server 402, which is operational with numerous other general purpose or special purpose computing system environments or configurations. Examples of well-known computing systems, environments, and/or configurations that may be suitable for use with computer system/server 402 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 402 may be described in the general context of computer system-executable instructions, such as program modules as further described below, being executed by a computer system. Generally, program modules may include routines, programs, objects, components, logic, data structures, and so on that perform particular tasks or implement particular abstract data types. Computer system/server 402 may be practiced as one node of a distributed cloud computing environment. In such cloud computing environments, tasks are performed by remote processing devices that are linked through a communications network. In a distributed cloud computing environment, program modules 418 may be stored in one or more local and remote computer system storage media, including memory storage devices.

As shown in FIG. 4, computer system/server 402 in cloud computing node 400 is shown in the form of a general-purpose computing device. The components of computer system/server 402 may include, but are not limited to, one or more processors or processing units 404, a system memory 406, and a bus 408 that couples various system components including system memory 406 to processor 404.

Bus 408 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media.

System memory 406, in one embodiment, implements the functions of processor-based device 100 or computer 250 and the processes described with reference to FIG. 3. The system memory 406 can include computer readable media in the form of volatile memory, such as random access memory (RAM) 410 and/or cache memory 412. Computer system/server 402 may further include other removable/non-removable, volatile/non-volatile computer system storage media. By way of example only, storage system 414 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 408 by one or more data media interfaces. As will be further depicted and described below, memory 406 may include at least one computer program product having a set (e.g., at least one) of program modules 418 stored that are configured to carry out functions of various embodiments of the invention.

Program/utility 416, having a set (at least one) of program modules 418, may be stored in memory 406 by way of example, and not limitation, as well as an operating system, one or more application programs, other program modules, and program data. Each of the operating system, one or more application programs, other program modules, and program data or some combination thereof, may be adapted to a networking environment. In some embodiments, program modules 418 carry out the functions and/or methodologies of various embodiments of the invention described herein such as the attestation logic 460.

With reference again to FIG. 4, computer system/server 402 may also communicate with one or more external devices 420 such as a keyboard, a pointing device, a display 422, etc. Such external devices 420 include one or more devices that enable a user to interact with computer system/server 402; and/or any devices (e.g., network card, modem, etc.) that enable computer system/server 402 to communicate with one or more other computing devices. Such communication/interaction can occur via I/O interfaces 424. In some embodiments, computer system/server 402 can communicate with one or more networks such as a local area network (LAN), a general wide area network (WAN), and/or a public network (e.g., the Internet) via network adapter 426. As depicted, network adapter 426 communicates with the other components of computer system/server 402 via bus 408. It should be understood that although not shown, other hardware and/or software components could be used in conjunction with computer system/server 402. Examples, include, but are not limited to: microcode, device drivers, redundant processing units, external disk drive arrays, RAID systems, tape drives, and data archival storage systems, etc.

### Computer Program Product Support

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Non-Limiting Examples

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for providing attestation of a user's medical condition, the method comprising:
determining on a first processor-based device if a set of one or more conditions has been satisfied using zero-knowledge verifiable computing; and
in response to the set of one or more conditions having been satisfied, sending an attestation calculated using a zero-knowledge verifiable computing technique to a second processor-based device that the set of one or more conditions have been satisfied.

2. The method of claim 1, wherein the sending the attestation further includes using a zero knowledge protocol to maintain privacy of a user of the first processor-based device.

3. The method of claim 1, further comprising:
receiving a request for the attestation of the set of one or more conditions from another user using a zero-knowledge protocol to maintain privacy of the user of the first processor-based device.

4. The method of claim 1, further comprising:
determining if a settable time period is expired; and
in response to the settable time period is expired along with the set of one or more conditions having been satisfied, sending an attestation that the set of one or more conditions have been satisfied using a zero-knowledge protocol to maintain privacy of the user.

5. The method of claim 1, wherein the set of one or more conditions are medical conditions of the user categorized as within a standard bounds or outside a standard bounds as an emergency.

6. The method of claim 1, wherein the set of one or more conditions are physiological conditions of the user categorized as within a standard bounds or outside a standard bounds as an emergency.

7. The method of claim 6, wherein the set of one or more conditions are physiological conditions of the first user are measured by one or more sensors communicatively coupled to the processor-based device.

8. The method of claim 7, wherein the processor-based device is a smart watch.

9. The method of claim 7, wherein the processor-based device is a smartphone.

10. The method of claim 1, wherein the zero-knowledge verifiable computing is one
of succinct computational integrity and privacy (SCIP) technique;
succinct non-interactive argument of knowledge (zk-snark) technique; and
probabilistically checkable proof (PCP) technique.

11. A system for providing a network based service, the system comprising:
a memory;
a processor communicatively coupled to the memory, where the processor is configured to perform
determining on a first processor-based device if a set of one or more conditions has been satisfied using zero-knowledge verifiable computing; and
in response to the set of one or more conditions having been satisfied, sending an attestation calculated using a zero-knowledge verifiable computing technique to a second processor-based device that the set of one or more conditions have been satisfied.

12. The system of claim 11, wherein the sending the attestation further includes using a zero knowledge protocol to maintain privacy of a user of the first processor-based device.

13. The system of claim 11, further comprising:
receiving a request for the attestation of the set of one or more conditions from another user using a zero-knowledge protocol to maintain privacy of the user of the first processor-based device.

14. The system of claim 11, further comprising:
determining if a settable time period is expired; and
in response to the settable time period is expired along with the set of one or more conditions having been satisfied, sending an attestation that the set of one or more conditions have been satisfied using a zero-knowledge protocol to maintain privacy of the user.

14. (canceled)

15. The system of claim 11, wherein the set of one or more conditions are physiological conditions of the user categorized as within a standard bounds or outside a standard bounds as an emergency.

16. The system of claim 15, wherein the set of one or more conditions are physiological conditions of the first user are measured by one or more sensors communicatively coupled to the processor-based device.

17. The system of claim 16, wherein the processor-based device is a smart watch.

18. The system of claim 16, wherein the processor-based device is a smartphone.

19. A non-transitory computer program product for providing attestation of a user's medical condition comprising a computer readable storage medium having computer readable program code embodied therewith, the computer readable program code configured to perform:
determining on a first processor-based device if a set of one or more conditions has been satisfied using zero-knowledge verifiable computing; and
in response to the set of one or more conditions having been satisfied, sending an attestation calculated using a zero-knowledge verifiable computing technique to a second processor-based device that the set of one or more conditions have been satisfied.

20. The non-transitory computer program product of claim 19, wherein the sending the attestation further includes using a zero knowledge protocol to maintain privacy of a user of the first processor-based device.
